(19) United States
(12) Patent Application Publication
(10) Pub. No.: US 2003/0224893 A1
(43) Pub. Date: Dec. 4, 2003

(54) Wobbling inner gearing planetary gear system and method of assembling external gears

(76) Inventor: Yo Tsurumi, Chiryu-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/383,225

(22) Filed: Mar. 7, 2003

(30) Foreign Application Priority Data
Mar. 8, 2002 (JP) 2002-64352

(51) Int. Cl. F16H 23/00

(52) U.S. Cl. 475/163

(57) ABSTRACT

The present invention is a wobbling inner gearing planetary gear system having planetary external gears, and a center axis being located inside a periphery of the planetary external gears. The external gears can be provided in a number of 2n where n is an integer of 2 or more. The 2n external gears can be arranged in an circumferential direction of the center axis with a phase difference of 360°/2n. The external gears form parallels, and two external gears of each pair are offset from each other by a 180° phase difference. The two external gears can be arranged adjacent to each other in an axial direction of the center axis.

### BACKGROUND OF THE INVENTION

1. Field of the Invention

The present invention relates to a wobbling inner gearing planetary gear system suitably applied to a reducer used for controlling joints of an industrial robot and the like.

2. Description of the Related Art

FIG. 6 and FIG. 7 illustrate one prior art example of a wobbling inner gearing planetary gear system. The illustrated example is a wobbling inner gearing planetary gear system applied to a reducer, and includes a plurality of (three in this example) planetary external gears, and the center shaft of the system is located inside the periphery of these external gears.

In a central portion of a casing 101 is disposed an input shaft 103 driven by a motor (not shown) to rotate. The input shaft 103 is coaxial with the center shaft 01 of the system itself.

Inside the casing 101 is arranged a thick, disk-like first support block 104 (on the left side in FIG. 6) and a second support block 105 (on the right side) facing each other in axial direction. If the casing 101 is stationary, these first and second support blocks 104 and 105 function as an output shaft.

Both the support blocks 104 and 105 are integrally coupled and fixed by three carrier bolts 150 extending parallel to the input shaft 103, with a certain distance provided therebetween by a carrier spacer 154. These elements together form a carrier.

The first support block 104 and the second support block 105 have respective center holes 114 and 115, in which the input shaft 103 is supported by means of bearings 109a and 109b such as to be rotatable along the inner peripheries of the holes 114 and 115. The input shaft 103 is a hollow member having a through hole 103a. On the outer periphery of the input shaft 103 between the bearings 109a and 109b are integrally formed eccentric elements 117a, 117b, and 117c, which are offset from each other by a certain phase difference (1200 in this example). Three external gears 118a, 118b, and 118c are attached to the eccentric elements 117a, 117b, and 117c by means of bearings 120a, 120b, and 120c, respectively.

Each of the external gears 118a, 118b, and 118c is provided with a plurality of inner roller holes 128a, 128b, and 128c, through which inner pins 107 and inner rollers 108 pass. These inner pins 107 passing through the external gears 118a, 118b, and 118c are arranged on the same pitch circle of the carrier bolts 150, and both axial ends of each inner pin 107 are fixedly fitted in respective inner pin retaining holes 110 formed in the first and second support blocks 104 and 105.

The external gears 118a, 118b, and 118c include external gear teeth 124 in a trochoidal profile or arc profile on their outer peripheries. On the outer side of the external gears 118a, 118b, and 118c is arranged an internal gear 125 that meshes with the external gears 118a, 118b, and 118c. The internal gear 125 is integrally formed on the inner periphery of the casing 101, and provided with internal gear teeth consisting of outer pins 126.

One turn of the input shaft 103 causes one turn of the eccentric elements 117a, 117b, and 117c, which causes the external gears 118a, 118b, and 118c to wobbly rotate around the input shaft 103. At this time, because of the internal gear 125 restricting the rotation of the external gears 118a, 118b, and 118c around their own axes, the external gears 118a, 118b, and 118c move along the wobbling path while inscribing with the internal gear 125.

If the number of teeth of the external gears 118a, 118b, and 118c is N, and the number of teeth of the internal gear 125 is N+1, the difference in the number of teeth between the inner and external gears is one. Because of this, every turn of the input shaft 103 causes the external gears 118a, 118b, and 118c to be shifted (rotated) by one tooth relative to the internal gear 125 fixed to the casing 101. This means that one turn of the input shaft 103 is reduced to 1/N turn of the external gears.

When this rotation of the external gears 118a, 118b, and 118c is transmitted to the output shaft via the inner pins 107, the wobbling component of the external gears 118a, 118b, 118c is absorbed by the gap between the inner roller holes 128a, 128b, and 128c and the inner pins 107, so that only the rotating component of them is transmitted.

As a result, a reduction rate of 1:1/N is achieved.

The provision of three external gears as with this prior art example increases power transmission capacity by three times as compared to a system with only one external gear.

The illustrated wobbling inner gearing planetary gear system is classified under a subgroup F16H1/32 of the International Patent Classification, because it includes planetary external gears 118a, 118b, and 118c and the system's center shaft 01 is located inside the periphery of the external gears 1118a, 118b, and 118c. This type of system generally has a problem of inevitable eccentric load (radial load) resulting from the wobbling motion of the external gears 118a, 118b, and 118c for every turn of the input shaft 103.

The reason why the three external gears 118a, 118b, and 118c are circumferentially arranged with a phase difference of 120° is to counterbalance the effects of eccentric loads of the respective external gears 118a, 118b, and 118c as much as possible so as to enable smooth power transmission with less vibration.

In response to the recent demands for reducers to be smaller and more powerful, it has been suggested that four or more external gears be assembled in a wobbling inner gearing planetary gear system for reducers. Such gear system with four or more external gears has not yet been manufactured for the following reasons.

Because of the structural characteristics of the gear system with four or more external gears, it could not impart smooth rotation if there were large manufacturing errors and assembling errors of the respective gears. On the other hand, an attempt to reduce the errors by increasing machining precision would result in extremely high costs.

Another problem in the system with four or more external gears is that because of the large axial span length of each external gear, the effects of eccentric load (as mentioned above) caused by the eccentric motion of each external gear are accordingly large; in particular, the effects of moment determined by the distance from the bearings are significant.

### SUMMARY OF THE INVENTION

The present invention has been devised under these circumstances, and an object thereof is to provide a wobbling inner gearing planetary gear system having four or more external gears which is small but has high transmission capacity, and which enables reduction of vibration and pulsation of the system by rational counterbalance of moments generated in the system.

To solve the above problems, the present invention provides a wobbling inner gearing planetary gear system having planetary external gears, a center shaft of the system being located inside periphery of the external gears. In this system, the external gears are provided in a number of 2n where n is an integer of 2 or more, and the 2n external gears are arranged in a circumferential direction of the center shaft with a phase difference of 360°/2n, the external gears forming pairs and two external gears of each pair being offset from each other by 180° phase difference; and the two external gears are arranged adjacent to each other in an axial direction of the center shaft.

According to the present invention, the 2n (even number) of external gears are circumferentially arranged with a phase-difference of 360°/2n around the center shaft, whereby the loads created around the center shaft are counterbalanced within the system.

For merely counterbalancing the loads in a system with four external gears, for example, the four external gears could be divided into two pairs and offset from each other by 180° phase difference. However, the present invention does not adopt this arrangement for achieving a better leveling effect of errors or torque changes resulting therefrom as will be described later.

As for the moments created at axially different points of the loads, because two external gears offset from each other by 180° phase difference out of the 2n external gears are arranged adjacent to each other in the axial direction of the center shaft, these moments caused by the eccentric motion of the external gears are well counterbalanced.

This structure only allows for an even number of external gears. The difference in the number of teeth between the external gears and internal gear may be set 2, for example, whereby a high reduction rate can be achieved.

The present invention, therefore, can be summarized as a wobbling inner gearing planetary gear system having planetary external gears, and a center shaft being located inside a periphery of the planetary external gears. The external gears can be provided in a number of 2n where n is an integer of 2 or more. The 2n external gears can be arranged in an circumferential direction of the center shaft with a phase difference of 36°/2n. The external gears form parallels, and two external gears of each pair are offset from each other by a 180° phase difference. The two external gears can be arranged adjacent to each other in an axial direction of the center shaft.

The invention also can include a method of assembling external gears in a wobbling inner gearing planetary gear system having planetary external gears and a center shaft of the system being located inside a periphery of the external gears. The method comprises selecting a number of the external gears to be 2n, where n is an integer of 2 or more. The 2n external gears are mounted in such a positional relationship that the 2n external gears are arranged in a circumferential direction of the center shaft with a phase difference of 360° over 2n. The external gears form pairs, and two external gears of each pair are offset from each other by a 180° phase difference. The two external gears are arranged adjacent to each other in an axial direction of the center shaft.

In another embodiment, the invention includes a wobbling inner gear planetary gear system having planetary external gears and a center shaft of the system located inside a periphery of the external gears. The external gears are provided in a number of m, where m is an integer of 4 or more. The m external gears are arranged in a circumferential direction of the center shaft, with a phase difference of 360°/m. The m external gears are arranged such that axially adjacent external gears are offset from each other by a maximum phase difference.

In another embodiment, the invention includes a method of assembling external gears in a wobbling inner gearing planetary gear system having planetary external gears. A center shaft of the system is located inside a periphery of the external-gears. The method comprises the steps of selecting a number of the external gears to be m, where m is an integer of 4 or more. An eccentric position is successively determined where the m external gears are arranged in a circumferential direction of the center shaft with a phase difference of 360°.

In these structures, the number of external gears should not necessarily be an even number, and can be an odd number of 5 or more, for example. In the case where the number of external gears is an odd number, there are no two external gears offset from each other by 180° phase difference when the external gears are arranged in the circumferential direction of the center shaft with 360°/m phase difference. However, by arranging the external gears in the axial direction of the center shaft such that one external gear is always offset from an immediately previously mounted-(adjacent) external gear by a maximum phase difference, the moments caused by the eccentric motion of external gears can be well counterbalanced.

### BRIEF DESCRIPTION OF THE DRAWINGS

FIG. 1 is a sectional side view of a reducer adopting a wobbling inner gearing planetary gear system according to one embodiment of the present invention;

FIG. 2 is a model view of an input shaft and external gears of this gear system;

FIG. 3 is an explanatory view showing relations between each of various arrangements in eccentric and axial directions of the external gears in this gear system, and moments and reaction forces of the bearing;

FIG. 4 is a model view of an input shaft and external gears of a six-gear system;

FIG. 5 is a model view of an input shaft and external gears of a five-gear system;

FIG. 6 is a sectional side view of a reducer adopting a conventional wobbling inner gearing planetary gear system; and

FIG. 7 is a cross section taken along the line V-V of FIG. 6.

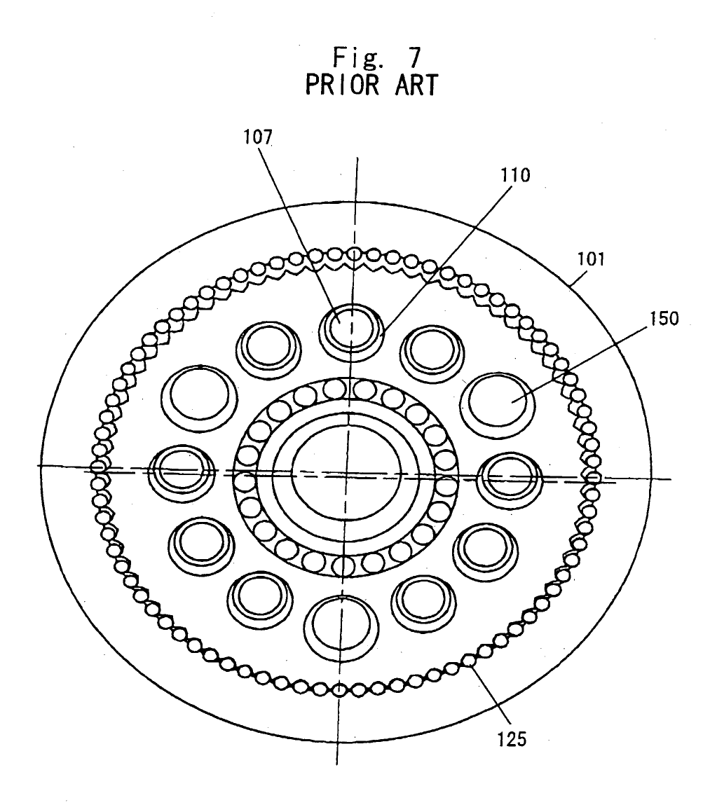

### DETAILED DESCRIPTION OF THE PREFERRED EMBODIMENTS

Preferred embodiments of the present invention will be hereinafter described with reference to the accompanying drawings.

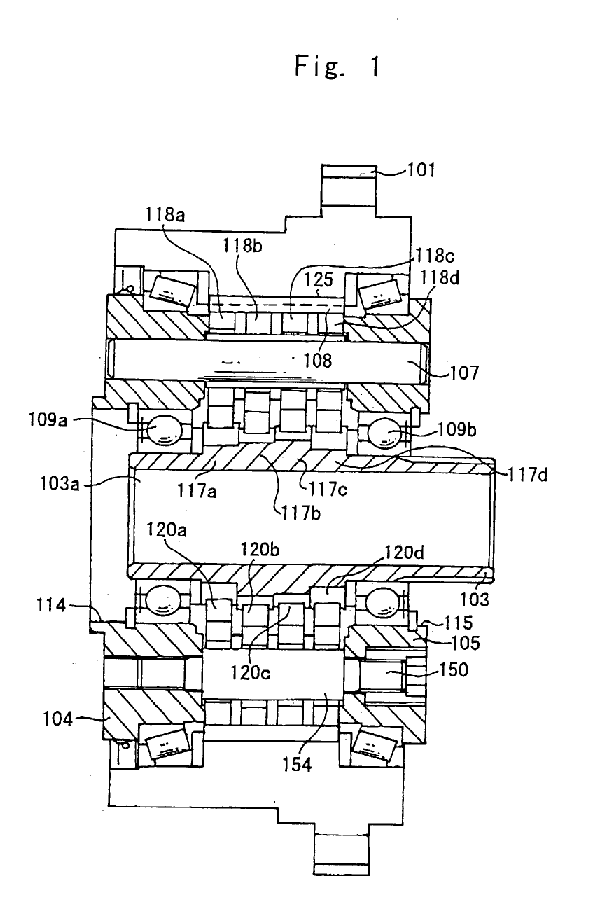

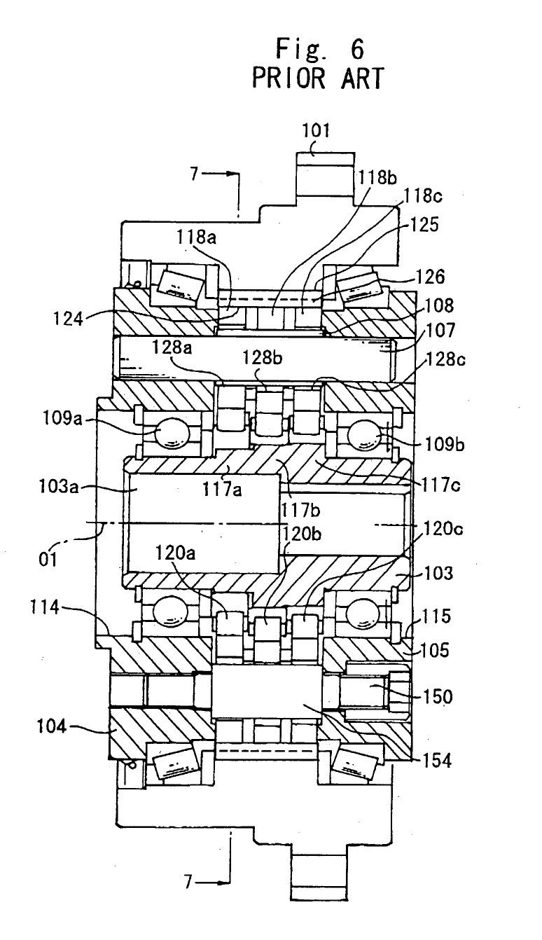

FIG. 1 is a sectional side view illustrating a wobbling inner gearing planetary gear system (reducer) according to one embodiment of the present invention. The drawing shows a part corresponding to the part shown in FIG. 6.

The reducer shown in FIG. 1 has substantially the same structure as the three-gear system shown in FIG. 6, apart from the feature that it has four (2n, n=2) external gears 118a-118d (the reducer will be hereinafter referred to as “four-gear system”). Same or similar constituent elements are given the same reference numbers as those of FIG. 6 and detailed description thereof will be omitted.

On the outer periphery of the input shaft 103 between the two bearings 109a and 109b are integrally formed eccentric elements 117a-I 17d, offset from each other by a predetermined phase difference. The four external gears 118a-118d are attached to these eccentric elements 117a-117d respectively by means of bearings 120a-120d.

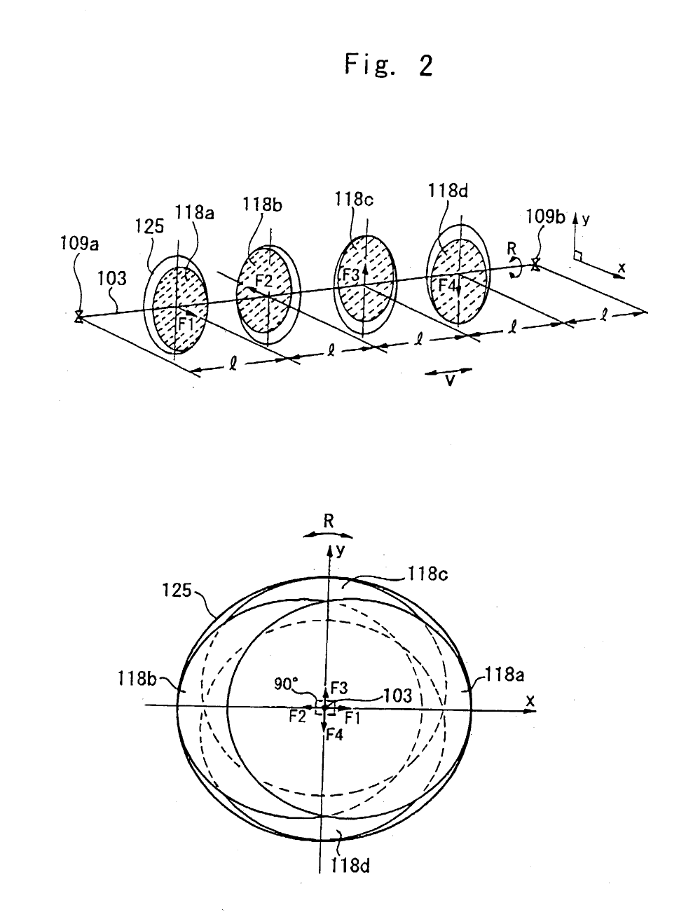

FIG. 2 is a model view illustrating the external gears 118a-18d of the four-gear system and the vicinity of the center shaft 01 of the wobbling inner gearing planetary gear system, which coincides with the center of the input shaft 103.

The four external gears 118a-118d are arranged in the circumferential direction R of the input shaft 103 via eccentric elements (not shown) with a phase difference of 90° (=360°/(2×2)). The external gears 118a and 118b, and the external gears 118c and 118d, which are offset from each other by a phase difference of 180°, are arranged adjacent to each other in the axial direction V of the input shaft 103.

One turn of the input shaft 103 causes the external gears 118a-118d to wobbly rotate around the input shaft 103 while maintaining the 90° phase difference. At this time, each of the external gears 118a-118d is involved with eccentric load F (F1-F4).

The external gears 118a-118d each cause moments M118a-M118d around the bearing 1109a, which can be theoretically expressed as follows when viewed from axial direction of the input shaft 103:

First, when an attention is focused on a component x of moment or Mx around the bearing 109a of the input shaft 103 on the left side of the drawing, component x of the moment M118a or Mx118a is obtained by multiplying a component x of the eccentric load F exerted on the external gear 118a by the distance I from the bearing 109a to the mounting position of the external gear 118a. Thus,

Mx118a=F×I=F·I.

Similarly,

Mx118b−F×2I=−2F·I

Mx118c=0×3=0

Mx118d0×4I=0.

Thus the component x of the moment or Mx around the bearing 109a is expressed as:

$$\begin{matrix}M x = M x118a + M x118b + M x118c + M x118d \\ = F \cdot I - 2 F \cdot I + 0 + 0 \\ = - F \cdot I .\end{matrix}$$

Similarly, the component y of the moment or My around the bearing 109a can be expressed as follows:

My118a=0×I=0

My118b=0×2I=0

My118c=F×3I=3F·I

My118d=−F×4I=−F·I

Thus the component y of the moment or My around the bearing 109a is expressed as:

$$\begin{matrix}M y = M y118a + M y118b + M y118c + M y118d \\ = 0 + 0 + 3 F \cdot I - 4 F \cdot I \\ = - F \cdot I .\end{matrix}$$

In other words, the moment around one of the bearings 109a of the input shaft 103 of the four-gear system according to the embodiment of the invention at the time point being discussed, can be considered as a sum of a moment F·I (x) which causes the input shaft 103 to rotate around the bearing 109a in a horizontal direction and a moment F·I (y) which causes the same to rotate in a vertical direction. At the same time, the directions of these moments will be rotating from the next time point onwards in accordance with the rotation of meshing positions.

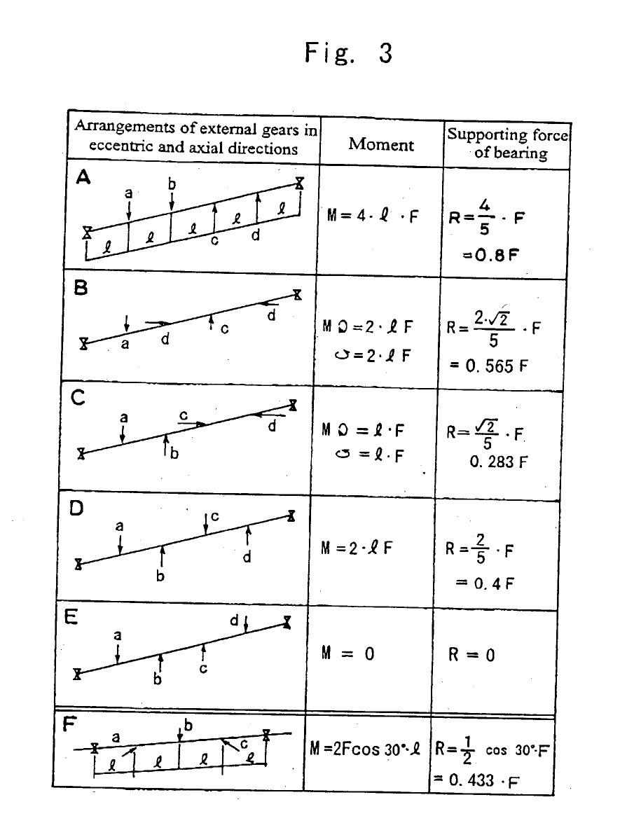

FIG. 3 shows theoretical values of moments around the bearing 109a and reaction forces of the opposite bearing 109b with respect to various different arrangements of external gears in eccentric and axial directions of the conventional three-gear system and various four-gear systems.

Reference numerals a-d in the figure denote each of the external gears, and the arrows indicate their eccentric directions (at a given time point).

Diagram A illustrates an arrangement in which external gears a and b have a 180° phase difference relative to external gears c and d in the circumferential direction of the shaft, and each pair of external gears a, b and c, d that are positioned in the same eccentric directions, i.e., not circumferentially offset from each other, are adjacent to each other in the axial direction.

Diagram B illustrates an arrangement in which external gears a-d are equally arranged around the circumference of the shaft with a 90° phase difference (360°/(2×2)).

Diagram C illustrates the arrangement of the four-gear system according to the embodiment of the present invention. The external gears a-d are arranged in the circumferential direction of the shaft with a 90° phase difference (360°/(2×2)), and the external gears a and b having a 180° phase difference and the external gears c and d having a 180° phase difference are respectively adjacent to each other in the axial direction.

Diagram D illustrates an arrangement in which external gears a and c have a 180° phase difference relative to external gears b and d in the circumferential direction of the shaft, and the external gears a and b having a 180° phase difference and the external gears c and d having a 180° phase difference are respectively adjacent to each other in the axial direction.

Diagram E illustrates an arrangement in which external gears a and d have a 180° phase difference relative to external gears b and c in the circumferential direction of the shaft, and the external gears a and b having a 180° phase difference and the external gears c and d having a 180° phase difference are respectively adjacent to each other in the axial direction.

Diagram F illustrates the arrangement of the conventional three-gear system, in which external gears are circumferentially arranged with a 120° phase difference.

As can be seen from FIG. 3, both the moments and reaction forces of the bearing are larger in the four-gear system of the arrangements A and B as compared to the conventional three-gear system, which means vibratory force generated in the system is larger than the conventional system. On the other hand, the moments (or reaction forces of the opposite bearing) are lower in the four-gear system having the arrangements C, D, and E as compared to the arrangement F of the conventional three-gear system.

Among these, the most favorable results were obtained with the arrangement E, in which both the moments and eccentric loads were zero.

A further test conducted by the inventors, however, showed that the arrangement C was superior to arrangement E in overall performance, because of the following possible reasons:

In the arrangements A, D, and E of the four-gear system in FIG. 3, the external gears are mounted such that two external gears are positioned in the same eccentric directions, and the remained two external gears are offset from each other with a 180° phase difference.

Therefore, two each external gears cause a moment in the same circumferential direction during rotation, i.e., when viewed in a cross section of the shaft, the external gears and internal gear make engagement with each other only at two circumferential points.

Assuming there is a possibility that the eccentric load of each external gear changes during rotation within a range of F±ΔF due to machining errors, if two external gears on one circumferential side are both offset to the side of F+ΔF, while the other two external gears on the opposite circumferential side are both offset to the side of F−ΔF, then the gear system as a whole will suffer performance deterioration by 4·ΔF.

Since this is the possible maximum level of adverse effects, it can be considered that the system with the arrangements A, D, or E shown in FIG. 3 will be operated between in a state where the effects of the errors are well counterbalanced whereby performance deterioration is zero, and in a state where the system suffers the effects of the errors to the maximum level of 4·ΔF.

On the other hand, the four-gear systems of the external gear arrangements B and C in FIG. 3 have each of the external gears circumferentially arranged with a 90° phase difference.

This means that the circumferentially equally spaced four external gears cause moments in their discrete directions during the operation. That is, when viewed in a cross section of the shaft, the external gears and internal gear always make engagement with each other at four circumferential points in these systems.

Based on the assumption made above that there is a possibility that the eccentric load of each external gear changes during rotation within a range of F±ΔF due to machining errors, these systems will only suffer the adverse effects by 2·ΔF even in a worst possible situation. That is, the system with the arrangements B and C shown in FIG. 3 will be operated4 between in a state where the effects of the errors are well counterbalanced whereby performance deterioration is zero, and in a state where the system suffers the effects of the errors to the level of 2·ΔF. The adverse effects are thus reduced to a half level; in other words, the arrangements B and C are superior to arrangements A, D, and E in error-leveling performance.

Moreover, a further test conducted by the inventors showed that this performance characteristic had a significant effect and in fact the arrangement C was superior to arrangement E in which both the eccentric load and moment are theoretically zero, and that this qualitative tendency was reproducible.

Based on these findings, the external gears in this embodiment are mounted according to the arrangement C shown in FIG. 3.

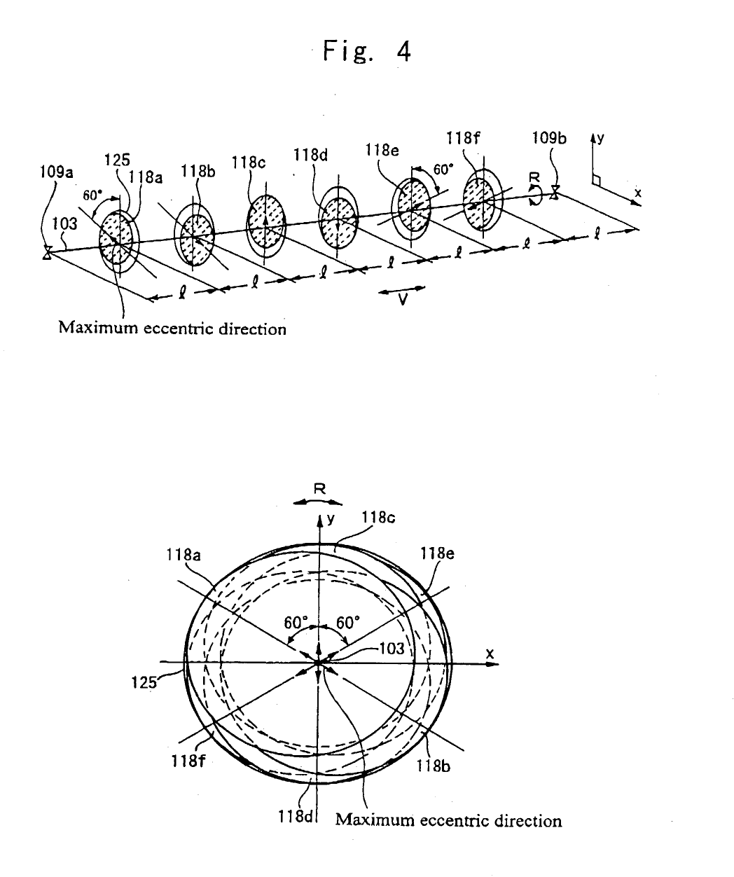

Next, another case in which six (2n, n=3) external gears are provided in the wobbling inner gearing planetary gear system will be discussed. As shown in FIG. 4, the six external gears 118a-118f may be arranged in the circumferential direction R of the input shaft 103 with a 60° (360°/(2×3)) phase difference. Further, of the six external gears 118a-18f, each pair of external gears 118a-118b, 118c-118d, and 118e-118f having a 180° phase difference may respectively be disposed adjacent to each other in the axial direction V of the input shaft 103.

Thereby, the moments caused by the eccentric motion of these pairs of external gears 118a-118b, 118c-118d, and 118e-118f are mutually counterbalanced because of the 180° phase difference. Thus the effect of counterbalancing the moments created by the eccentric motion of the six external gears is enhanced, and power transmission capacity is increased.

The present invention has been described above in specific terms wherein the number of external gears is 4 or 6, i.e., 2n (n: integer of 2 or more). The following is a more general definition of the present invention considered as an assembling technique of external gears for a wobbling inner gearing planetary gear system: An m-gear system, where m is the number of external gears and an integer of 4 or more, having m external gears arranged in a circumferential direction of a center shaft with a phase difference of 360°/m, the m external gears are arranged successively in an axial direction of the center shaft at an eccentric position where axially adjacent external gears are offset from each other by a maximum phase difference with reference to an eccentric position of an external gear positioned at one axial end thereof.

In other words, it is a method of assembling m external gears in an m-gear system, including the steps of mounting, successively determining an eccentric position where the m external gears are arranged in the circumferential direction of the center shaft with a phase difference of 360°/m and adjacent external gears are offset from each other by a maximum phase difference with reference to an eccentric position of an immediately previously mounted external gear, and arranging the m external gears successively at the determined eccentric positions.

Alternatively, the present invention can be defined as an m-gear system, where m is the number of external gears and an integer of 4 or more, the system having the m external gears arranged in a circumferential direction of a center shaft with a phase difference of 360°/m, so that adjacent external gears are offset from each other by a maximum phase difference.

It is, in other words, a method of assembling m (an integer of 4 or more) external gears in an m-gear system, including the steps of arranging the m external gears successively in the circumferential direction of the center shaft with a phase difference of 360°/m, so that adjacent external gears are offset from each other by a maximum phase difference.

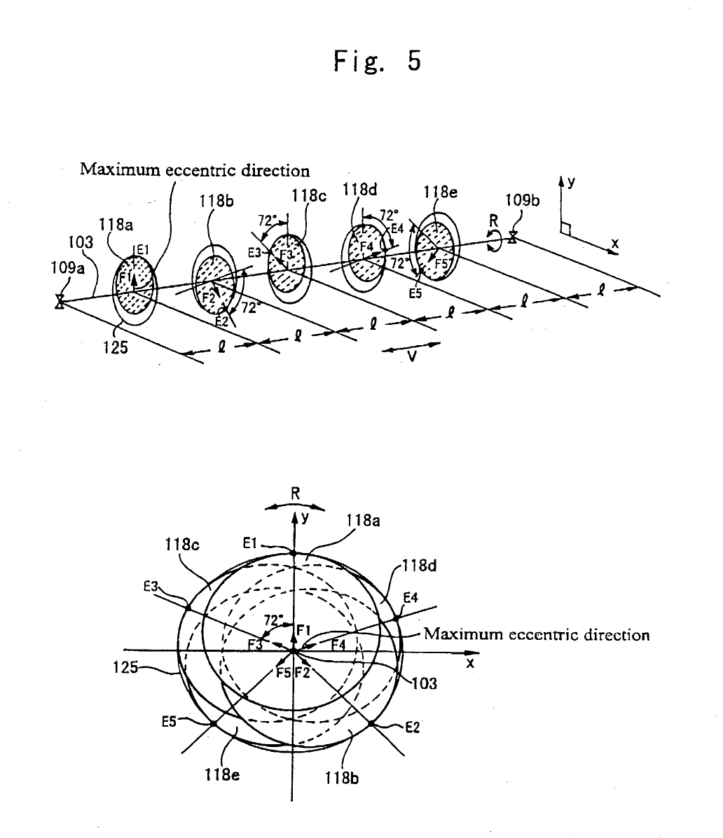

For example, when a wobbling inner gearing planetary gear system having five external gears (m=5) is adopted, as shown in FIG. 5, five external gears 118a-118e are arranged in the circumferential direction R of the input shaft 103 with a phase difference of 72° (360°/5).

The external gears are arranged in the axial direction V of the input shaft 103 such that, after mounting the external gear 118a, the position of the external gear 118b is determined as an eccentric position E2 or E5 (E2 in the illustrated example), where the external gear 118b is offset from the eccentric position E1 of the immediately previously mounted external gear 118a by a maximum phase difference of 114°, and then the external gear 118b is mounted at this eccentric position E2. The other external gears 118c, 118d, and 118e are likewise mounted at positions E3, E4, and E5, respectively, where they are offset from the immediately previously mounted external gear by a maximum phase difference.

Thereby, the moments caused by the eccentric motion of the external gears are mutually counterbalanced because of the maximum phase difference between the adjacent external gears. Thus the effect of counterbalancing the moments created by the eccentric motion of the five external gears is enhanced, and power transmission capacity is increased.

As described above, the present invention realizes a wobbling inner gearing planetary gear system having four or more external gears, which is small but has increased power transmission capacity, and which enables reduction of vibration and pulsation of the system by rational counterbalance of moments generated in the system.

What is claime4d is:

1. A wobbling inner gearing planetary gear system, comprising:
planetary external gears; and
a center axis being located inside a periphery of the planetary external gears, wherein said external gears are provided in a number of 2n where n is an integer of 2 or more, and said 2n external gears are arranged in a circumferential direction of said center axis with a phase difference of 360°/2n, wherein said external gears form pairs and two external gears of each pair are offset from each other by 180° phase difference, and wherein said two external gears are arranged adjacent to each other in an axial direction of said center axis.

2. A method of assembling external gears in a wobbling inner gearing planetary gear system having planetary external gears, a center axis of the system being located inside a periphery of the external gears, the method comprising the steps of:
selecting a number of the external gears to be 2n, where n is an integer of 2 or more; and
mounting said 2n external gears in such a positional relationship that said 2n external gears are arranged in a circumferential direction of the center axis with a phase difference of 360°/2n,
wherein said external gears form pairs and two external gears of each pair are offset from each other by 180° phase difference, and wherein said two external gears are arranged adjacent to each other in an axial direction of said center axis.

3. A wobbling inner gearing planetary gear system, comprising:
planetary external gears; and
a center axis of the system located inside a periphery of the external gears, wherein said external gears are provided in a number of m where m is an integer of 4 or more, and said m external gears are arranged in a circumferential direction of said center axis with a phase difference of 360°/m, and wherein said m external gears are arranged such that axially adjacent external gears are offset from each other by a maximum phase difference.

4. A wobbling inner gearing planetary gear system as recited in claim 3, wherein the maximum phase difference is with reference to an eccentric position of an external gear positioned at one axial end of the center axis.

5. A method of assembling external gears in a wobbling inner gearing planetary gear system having planetary external gears, a center axis of the system being located inside periphery of the external gears, the method comprising the steps of:
selecting a number of the external gears to be m, where m is an integer of 4 or more;
successively determining an eccentric position where said m external gears are arranged in a circumferential direction of the center axis with a phase difference of 360°/m, and axially adjacent external gears are offset from each other by a maximum phase difference with reference to an eccentric position of an immediately previously mounted external gear; and
mounting said m external gears at said determined eccentric position.

6. A method of assembling external gears in a wobbling inner gearing planetary gear system having planetary external gears, a center axis of the system being located inside periphery of the external gears, the method comprising the step of:
mounting said m external gears selecting a number of the external gears to be m, where m is an integer of 4 or more, and in such a positional relationship that the m external gears are arranged in a circumferential direction of the center axis with a phase difference of 360°/m, and that two adjacent external gears are offset from each other by a maximum phase difference.
